(19) United States
(12) Patent Application Publication
(10) Pub. No.: US 2002/0160781 A1
(43) Pub. Date: Oct. 31, 2002

(54) System, method and apparatus for facilitating resource allocation in a communication system

(76) Inventors: Gunnar Bark, Linkoping (SE); Ke Wang Helmersson, Linkoping (SE); Niclas Wiberg, Linkoping (SE)

Correspondence Address: Raymond Van Dyke, Jenkens & Gilchrist, P.C., Suite 3200, 1445 Ross Avenue, Dallas, TX, 75202-2799, US

(21) Appl. No.: 09/791,987

(22) Filed: Feb. 23, 2001

(51) Int. Cl. H04Q 7/20

(52) U.S. Cl. 455/450; 455/452; 455/67.1; 455/509

(57) ABSTRACT

A system, method, and apparatus for the efficient allocation of dedicated and/or shared downlink communication channels for packet data users in a communication system. The present invention provides a switching scheme in which users which are close to a base station are allocated a downlink shared channel in order to save channelization codes in the system, whereas users that are far from a base station are allocated a downlink dedicated channel in order to conserve transmission power.

### BACKGROUND OF THE INVENTION

1. Technical Field of the Invention

The present invention generally relates to the allocation of radio resources in a communication system.

2. Background and Objects of the Present Invention

The code division multiple access (CDMA) communication method was developed to allow multiple users to share radio communication resources. In the general CDMA method, each user is assigned a unique code sequence to be used to encode its information signal. A receiver, knowing the code sequences of the user, can decode the received signal to reproduce the original information signal. The use of the unique code sequence during modulation provides for an enlarging of the spectrum of the transmitted signal resulting in a spread spectrum signal. The spectral spreading of the transmitted signal gives rise to the multiple access capability of CDMA.

If multiple users transmit spread spectrum signals at the same time, the receiver will still be able to distinguish a particular user's signal, provided that each user has a unique code and the cross-correlation between codes is sufficiently low. Ideally, the cross-correlation should be zero, i.e., the codes should be orthogonal in the code space. Correlating a received signal with a code signal from a particular user will result in the despreading of the information signal from that particular user, while signals from other users will remain spread out over the channel bandwidth.

However, the number of orthogonal codes in a system is limited. As a result, each cell has a limited number of orthogonal channelization codes that are assigned different physical channels. The number of orthogonal channelization codes is dependent upon their spreading factor, which is related to the physical channel bitrates. This gives rise to the well-known downlink channelization code limitation inherent in CDMA.

Various multiple access methodologies may be employed using CDMA techniques. In direct sequence CDMA (DS-CDMA), the information signal is directly modulated by the unique code signal and then further modulated by a method such as PSK, BPSK, QPSK, etc. In frequency hopping CDMA (FH-CDMA), the carrier frequency of the modulated information signal is changed periodically. The hopping pattern is decided by the code signal. In time hopping CDMA (TH-CDMA), the data signal is transmitted in rapid bursts at time intervals determined by the code assigned to each user. Hybrid CDMA systems exist which employ a combination of spread spectrum and multiple access techniques such as DS/FH CDMA, DS/TH CDMA, etc.

FIG. 1 illustrates a typical wireless CDMA communication system, generally designated by the reference number 100, such as that of the IS-95 standard. A mobile station (MS) 105, e.g., a mobile telephone, communicates with one or more base transceiver stations (BTS) or base stations (120a, 120b) using a CDMA method. Each ETS serves a certain area which is referred to as a cell. Communication from the BTS (120a, 120b) to the MS (105) is referred to as a downlink (115a, 115b), while communication from the MS (105) to the BTS (120a, 120b) is referred to as an uplink (110a, 110b). Each BTS (120a, 120b) is connected using links (125a, 125b) to a base station controller (BSC) 130 which controls the functions of the BTSs (120a, 120b) In addition, the BSC 130 is connected to a communication network such as a public switched telephone network (PSTN) 140 using a link 135 to provide an interface between the land phone system and the wireless system.

Typically a mobile station will be in communication with a single base station at a time. Usually, a mobile station performs a handoff to switch to another base station when the signal strength of a neighboring cell exceeds the signal strength of the current cell within a given threshold. For example, MS 105 may switch from BTS 120a to BTS 120b, which is referred to in CDMA as a hard handoff.

A soft handoff occurs when a mobile station is connected to more than one base station at the same time. For example, MS 105 may be connected to BTS 120a and to BTS 120b simultaneously. Soft handoff is used in CDMA to reduce interference from other cells, reduce required base station transmission power, and to improve performance through macro diversity.

The downlink physical channel structure for IS-95 includes a pilot channel, a synchronization channel, a paging channel, and downlink traffic channels. The pilot channel, paging channel, and synchronization channel are common control channels, while the traffic channels are dedicated channels. A common channel is a channel which is shared among users, while a dedicated traffic channel is a channel allocated for a single user. Each traffic channel contains one fundamental code channel and may contain 1-7 supplemental code channels. A power control bit is multiplexed into the fundamental code channel for each power control group. Each downlink channel is modulated using a different spreading code.

The uplink physical channel structure has two physical channels, a traffic channel and a common access channel. The traffic channel is a dedicated channel which consists of a single fundamental channel and 0-7 supplemental channels. The common access channel is used by a mobile station to initiate a call, to respond to a paging channel message from a base station, and for location updates. Each access channel is associated with a downlink paging channel. Consequently, there can be up to seven access channels.

An improvement of the CDMA method, known as Wideband CDMA (WCDMA), is currently under development by a number of organizations around the world. One of the most popular of these WCDMA efforts is that of the Third Generation Partnership Project. Some of the goals of WCDMA include support for increased bandwidth and bitrates, and provision for packet data communication.

FIG. 2 illustrates an exemplary wireless WCDMA communication system, generally designated by the reference number 200. User equipment (UE) 205, e.g., a mobile station, communicates with one or more Node B components (220a, 220b) using a WCDMA method. A Node B functions as a base station in the WCDMA system, analogous to the BTS of the CDMA system. Each Node B serves a service area which is referred to as a cell. Communication from the Node B (220a, 220b) to the UE (205) is referred to as a downlink (215a, 215b), while communication from the UE (205) to the Node B (220a, 220b) is referred to as an uplink (210a, 210b). Each Node B (120a,120b) is connected using links (225a, 225b) to a radio network controller (RNC) 230 which controls the functions of the Node Bs (220a,220b). In addition, the RNC 230 is connected to a core network (CN) 240 using an interface 235. The core network may provide a connection to other networks 250, such as a public switched telephone network (PSTN) or base stations of other wireless access technologies, such as CDMA or GSM.

WCDMA provides for two groups of physical layer transport channels, common transport channels and dedicated transport channels. Common transport channel types include: a random access channel (RACH), a contention based uplink channel used for transmission of relatively small amounts of data; ODMA random access channel (ORACH), a contention based channel used in relay link; common packet channel (CPCH), a contention based channel used for transmission of bursty data traffic; forward access channel (FACH), a common downlink channel without closed-loop power control used for transmission of relatively small amounts of data; downlink shared channel (DSCH), a downlink channel shared by several UEs for carrying control or traffic data; uplink shared channel (USCH), an uplink channel shared by several UEs carrying control or traffic data; broadcast channel (BCH), a downlink channel used for broadcast of system information into an entire cell; and paging channel (PCH), a downlink channel used for broadcast of control information into an entire cell.

The dedicated physical transport channels in WCDMA include: a dedicated channel (DCH), a channel dedicated to one UE used in uplink or downlink; fast uplink signalling channel (FAUSCH), an uplink channel used to allocate dedicated channels in conjunction with FACH; and ODMA dedicated channel (ODCH), a channel dedicated to one UE used in relay link.

WCDMA also provides for a number of logical channels which are mapped onto the transport channels, which are in turn mapped onto physical channels. These logical channels may be classified according to two groups, control channels and traffic channels. Control channels are used to transfer control information only and include: a broadcast control channel (BCCH), a paging control channel (PCCH), a common control channel (CCCH), a dedicated control channel (DCCH), a shared channel control channel (SHCCH), an ODMA common control channel (OCCH), and an ODMA dedicated control channel (ODCCH). Logical traffic channels in WCDMA include a dedicated traffic channel (DTCH), an ODMA dedicated traffic channel (ODTCH), and a common traffic channel (CTCH).

A DCH transport channel user is assigned its own downlink dedicated physical channel (downlink DPCH) with its own channelization code. If each of many low-activity packet data users are assigned a downlink DPCH, a downlink code shortage may occur since the packet data users occupy the downlink codes even when they are inactive.

The DSCH transport channel is also mapped to one physical downlink shared channel (PDSCH) with a channelization code, but may carry the traffic of many users. Thus, the traffic variations of the packet data users can be “averaged out” allowing the channelization code to be better utilized, resulting in less code shortage.

Base station transmission power in a downlink is also a limited resource within CDMA communication systems. For example, if too many users are offered too much downlink traffic, the base station will reach its maximum transmission power level.

Thus, in CDMA communications systems, such as WCDMA, base station transmission power and channelization code availability are two crucial limited radio interface resources that should be allocated efficiently for communication system operation. The present invention provides for the efficient allocation of dedicated and/or shared downlink communication channels for packet data users in a communication system.

### SUMMARY OF THE INVENTION

The present invention is directed to a method, system, and apparatus for the efficient allocation of dedicated and/or shared downlink communication channels for packet data users in a communication system. The present invention provides a switching scheme in which users which are close to a base station are allocated a downlink shared channel in order to save channelization codes in the system, whereas users that are far from a base station are allocated a downlink dedicated channel in order to conserve transmission power.

### BRIEF DESCRIPTION OF THE DRAWINGS

A more complete understanding of the system, method and apparatus of the present invention may be had by reference to the following Detailed Description when taken in conjunction with the accompanying Drawings wherein:

FIG. 1 illustrates a typical wireless CDMA communication system;

FIG. 2 illustrates an exemplary wireless WCDMA communication system, generally designated by the reference number 200;

FIG. 3 illustrates generally at 300, the exemplary method of the present invention in flowchart form of switching a given user i between a DSCH state and a DCH state;

FIG. 4 illustrates generally at 400, the exemplary method of the present invention in flowchart form of switching a given user i between a DCH state and a DSCH state;

FIG. 5 illustrates the equivalent bit rate as a function of the average number of web users per cell for each of the four simulated schemes;

FIG. 6 illustrates the mean downlink transmission power as a function of the average number of web browsing users per cell for each of the four simulated schemes;

FIG. 7 illustrates the transmitted energy per correctly received data bit as a function of the average number of web browsing users per cell for each of the four simulated schemes;

FIG. 8 illustrates the mean code tree usage as a function of the average number of web browsing users per cell for each of four simulated schemes.

### DETAILED DESCRIPTION OF THE PRESENTLY PREFERRED EXEMPLARY EMBODIMENTS

The present invention will now be described more fully hereinafter with reference to the accompanying Drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As described, in CDMA communications systems, such as WCDMA, base station transmission power and channelization code availability are two crucial limited radio interface resources that should be allocated efficiently for communication system operation. An embodiment of the present invention provides for the efficient allocation of dedicated and/or shared downlink communication channels for packet data users. In order to save downlink channelization codes, a number of WCDMA packet data users may share a single channelization code by fast multiplexing the users onto a downlink shared channel (DSCH). The main drawback of DSCH compared to the use of dedicated channels (DCH), is the absence of macro diversity, i.e. soft handoff. The choice between DSCH and DCH is therefore a resource tradeoff between downlink channelization code usage and base station power.

An exemplary embodiment of the present invention describes a method for switching between the use of a dedicated channel (DCH) and a downlink shared channel (DSCH) for WCDMA packet data users. According to an exemplary method in accordance with the present invention, users located close to the base stations are allocated a downlink shared channel (DSCH) in order to save channelization codes, whereas users located far from base stations are allocated a dedicated channel (DCH) in order to conserve transmission power.

The WCDMA specification provides for a downlink shared channel (DSCH), in which a number of users share a downlink physical channel by means of fast multiplexing. A primary advantage of DSCH is that many packet users with relatively low usage activity can share a single downlink channelization code. As an alternative, a dedicated channel (DCH) with its own downlink channelization code may be allocated to each user. However, if the number of users requiring a DCH becomes larger than the number of available downlink channelization codes, the system needs to switch users between DCH and common channels in order to serve all of the users. Since this channel switching procedure is slower than the fast DSCH multiplexing, the code utilization, system throughput, and packet delay may become worse for DCH in the code-limited case.

Since the DSCH is transmitted from only one access point, i.e., in only one cell, the DSCH users do not benefit from macro-diversity (soft handover gain) as the DCH users do. Hence, users close to cell borders require larger downlink transmission power if they are allocated a DSCH instead of a DCH. However, a DCH user in soft handover allocates a downlink channelization code in each cell it is connected to, providing a further increased risk for code blocking.

In the WCDMA communication system, the user equipment, e.g., a mobile phone, operates in a number of states as referred to in the Third Generation Partnership Project; Technical Specification Group Radio Access Network; RRC Protocol Specification (3G TS 25.331). Normally, a new packet data user with relatively large capacity requirements is switched to a CELL_DCH protocol state after the initial signalling on RACH and FACH. While users with relatively continuous downlink data flow, e.g. streaming content, may be allocated a DCH without capacity loss, such an allocation may be undesirable for bursty downlink traffic, such as that required for web browsing users, due to channelization code limitations.

According to the present invention, user equipment (UE) receives downlink data on dedicated channels (DCH) and/or downlink shared channels (DSCH). Two new user operating states, a DCH state and a DSCH state, are introduced by the present invention. In a first state, the DCH state, the user has a downlink DCH mapped onto a dedicated physical data channel (DPDCH), and a dedicated physical control channel (DPCCH) for physical layer (layer 1) control signalling according to the protocol. No requirements are set on the DCH bitrate, but exemplary typical values may be 10-100 kbits/s in order to prevent allocating too much of the cell resources to one DCH user.

In a second state, the DSCH state, the user has a downlink DSCH mapped onto a physical DSCH, and a dedicated physical control channel (DPCCH) for layer 1 control signalling according to the protocol. No requirements are set on the DSCH bitrate, but exemplary typical values may be 300-500 kbits/s in order to not allocate too much of the cell resources to the DSCH users. In the DSCH state the user may also have a DCH mapped onto a DPDCH, in addition to the DSCH. The DCH may be used to carry circuit-switched data, such as speech, etc., while the DSCH carries the downlink packet data.

In both the DCH state and the DSCH state, the user has a DCH for uplink traffic and layer 1 control according to the protocol.

According to the method of the present invention, users close to the base stations are allocated a DSCH in order to save channelization codes in the system. Users far away from the base stations are allocated a DCH in order to conserve transmission power. As users move throughout the communication system, the users are switched between the DCH states and DSCH states according to conditions and measurements in the system, such as a signal threshold.

An exemplary method according to the present invention for switching a given user i between a DSCH state and a DCH state is given by the following procedure:

Switch state of user i from DSCH to DCH if:

There are free DL channelization codes for DCH

| | |
|---|---|
| AND | { |

(link quality to serving cell)_{db} − (link quality to
second best cell)_{db} < cell_diff_switch_th
OR
(DSCH_power of user i)_{db} > DSCH_pow_switch_th
}

FIG. 3 illustrates generally at 300, the exemplary method of the present invention in flowchart form for switching a given user i between a DSCH state and a DCH state. For a user i currently in a DSCH state (step 310), it is first determined if there are free downlink channelization codes for a dedicated channel (DCH) (step 320). If the condition of step 320 is true, and a link quality differential between the serving cell and a second best cell is less than a threshold value (step 330), or the DSCH power of user i is greater than a threshold value (step 340), user i is switched to the DCH state (step 350).

An exemplary method according to the present invention for switching a given user i between a DCH state and a DSCH state is given by the following procedure:

| Switch state of user i from DCH to DSCH if: | |
|---|---|
| | There is a potential channelization code shortage |
| OR | { |

(link quality to serving cell)_{db} − (link quality to
second best cell)_{db} > cell_diff_switch_th
AND
(Expected_DSCH_power of user i)_{db} <
DSCH_pow_switch_th)
}

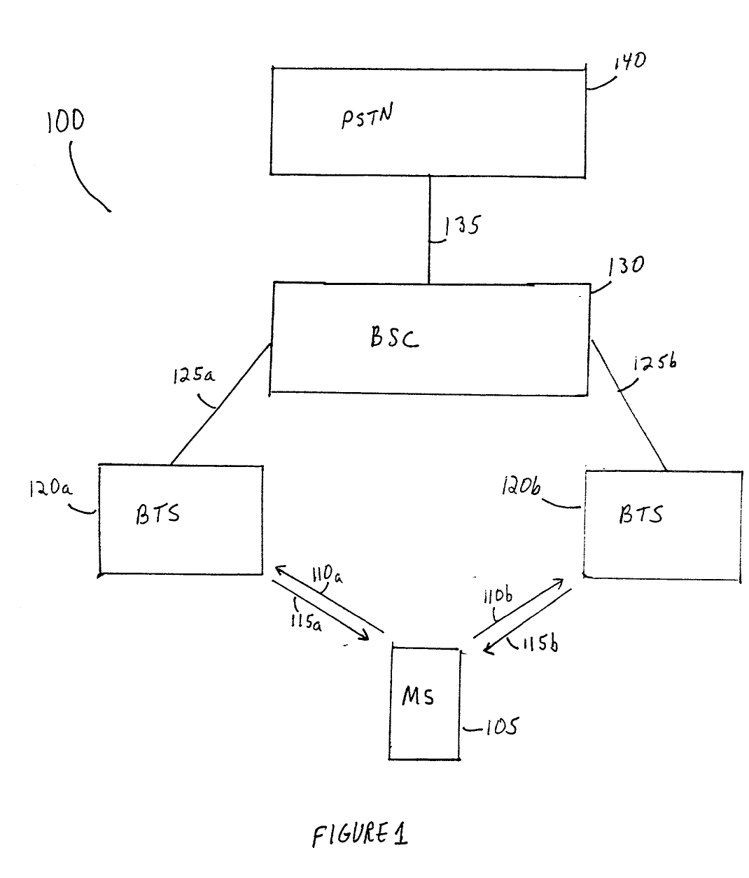

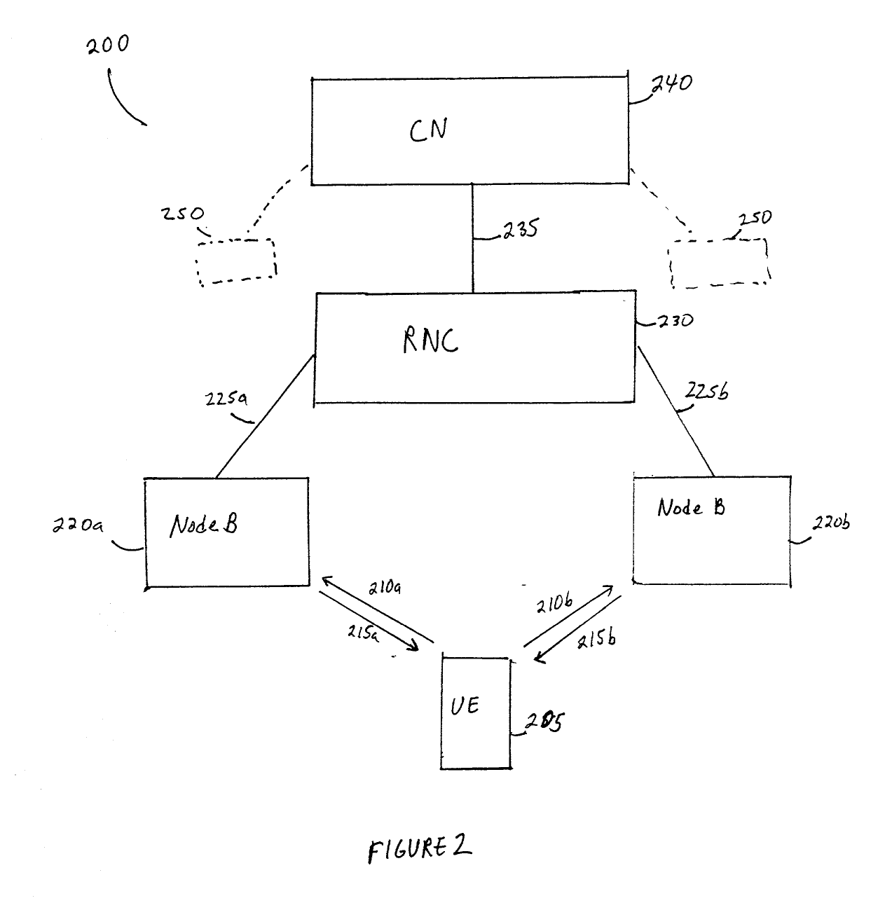

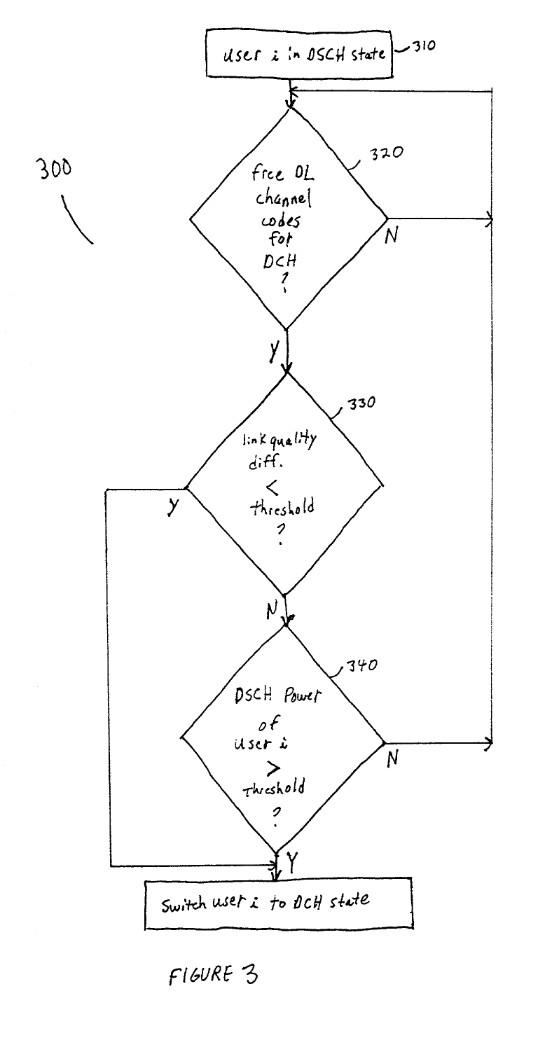

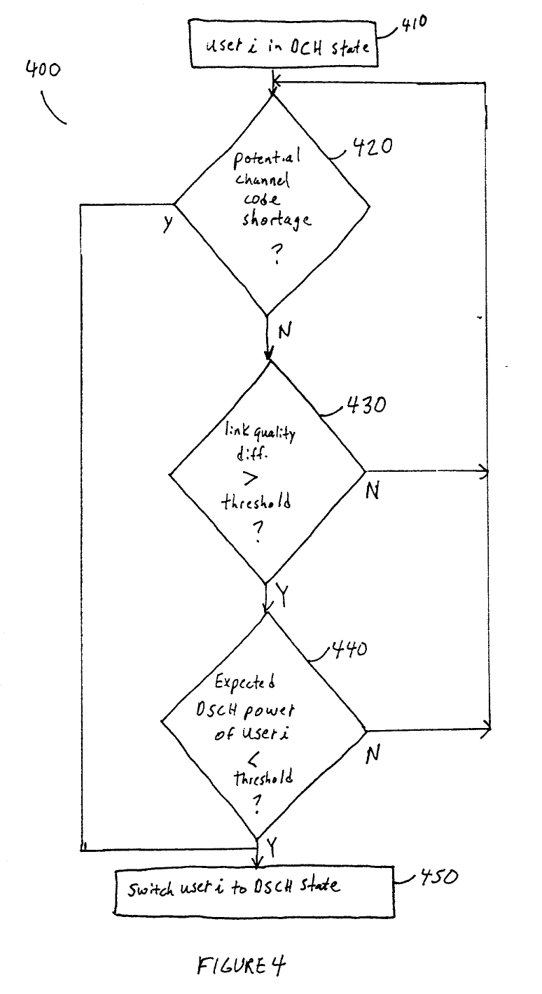

FIG. 4 illustrates generally at 400, the exemplary method of the present invention in flowchart form for switching a given user i between a DCH state and a DSCH state. For a user i currently in a DCH state (step 410): if there is a potential channelization code shortage (step 420); or a link quality differential between the serving cell and a second best cell is greater than a threshold value (step 430), and the expected DSCH power of user i is less than a threshold value (step 440); user i is switch to the DSCH state (step 450).

The two thresholds, cell_diff_switch_th and DSCH_pow_switch_th may be set according to desired values and preferably should be associated with hysteresis or time-to-trigger requirements to avoid ping-pong effects. The threshold value cell_diff_switch_th should be set at the desired dB level of difference in link quality between the serving cell and the second best cell at which it would be desirable to switch between the DCH state and the DSCH state. For example, cell_diff_switch_th may be set equal to Reporting range 1A+Hysteresis 1A as specified by the 3GPP RRC specification.

The link quality refers to the information element (IE) “Measurement quantity” in the RRC Measurement Control command. This information element defines the quantity that the user equipment measures for handover purposes on different cells, such as a power-to-interference ratio.

The DSCH_power value of each user may be estimated by measuring the power on the associated downlink DPCCH and adding an offset. The offset may be needed because, due to varying fading and interference conditions, the optimum DSCH power to each mobile varies with time and position. One method of setting the offset is for the UE to measure the received signal-to-interference ratio (SIR) on the downlink DPCCH, and inform the Node B if the power on the downlink DPCCH should be increased or decreased. This is known as fast inner-loop power control and ensures that the power of the DPCCH follows the fading and interference variations. This may be performed for all DCH transmissions in WCDMA. If the power of the physical DSCH is set to the power of the associated downlink DPCCH plus a power offset, the physical DSCH will also follow the channel variations in a desired manner. The size of the offset may depend upon the bitrate of the DSCH. Higher bitrates require more power, i.e., a higher offset. The offset is thus the difference in transmitted power between DPCCH and DSCH when both are received with a desired quality.

The downlink DPCCH power is measured in serving Node B and reported to the radio network controller (RNC) via the Node B Application Part (NBAP) protocol as described in the NBAP specification (3GPP TS 25.433). The Expected_DSCH_power is the downlink DSCH power level that the network expects the user to require if the user is switched from the DCH state to the DSCH state. The Expected_DSCH_power may be estimated from the current value of the downlink DCH power measured in Node B, with an added offset as described above, i.e., the difference in transmitted power between the DPCCH and DSCH when both are received with a desired quality.

As an alternative to using DSCH power estimations in the switching decisions of the present invention, the switching decisions may be based on downlink path loss measurements in the user equipment, which provides similar performance.

The performance of an exemplary embodiment of the channel allocation method of the present invention was evaluated using WCDMA radio network simulations. Four different channel allocation schemes for WCDMA packet data users were compared. In the simulations, each channel allocation scheme allocated half of the cells′ total downlink channelization code resource for packet data users, while the other half of the code resource was assumed to be allocated for other services, such as speech, streaming content, etc.

In the first allocation scheme, designated DCH 96, each user is allocated one of the sixteen available downlink 96 kbit/s dedicated channels (DCH) in every cell to which it is connected. User connections may be made to more than one cell as a result of soft handover.

In the second allocation scheme, designated DCH 416, each user is allocated one of the four available downlink 416 kbits/s dedicated channels (DCH) in every cell it is connected to. Once again, user connections may be made to more than one cell as a result of soft handover.

In the third allocation scheme, designated DSCH 416, each user is time-multiplexed onto any of the 4 available 416 kbits/s downlink shared channels (DSCH) in the cell that the user is connected to.

In a fourth allocation scheme, designated DSCH 416+DCH 96, the DSCH 416 and DCH 96 scheme are combined according to the methods of the present invention. For simplicity of implementation, the selection criterion for the simulation was path gain based instead of DSCH power based.

The performance of each of the four schemes was evaluated by use of the radio network simulations in which average packet data user bitrate and base station transmission power were simulated. The simulations were performed using a radio network simulator and include all relevant radio characteristics (e.g., multipath fading, intra- and inter-cell interference), WCDMA functions (e.g. power control, soft handover), and realistic models of the downlink traffic generated by web browsing users.

FIG. 5 illustrates the equivalent bit rate as a function of the average number of web users per cell for each of the four simulated schemes. The resulting data throughput, in which the average circuit-switched equivalent bit rate (data volume/waiting time) is plotted against the average number of web browsing users per cell, can be seen for each of the four simulated schemes. For low loads, the DCH 416 scheme and the two DSCH schemes perform best due to high peak rates. However, for high loads code blocking seriously degrades throughput for DCH 416 and DCH 96.

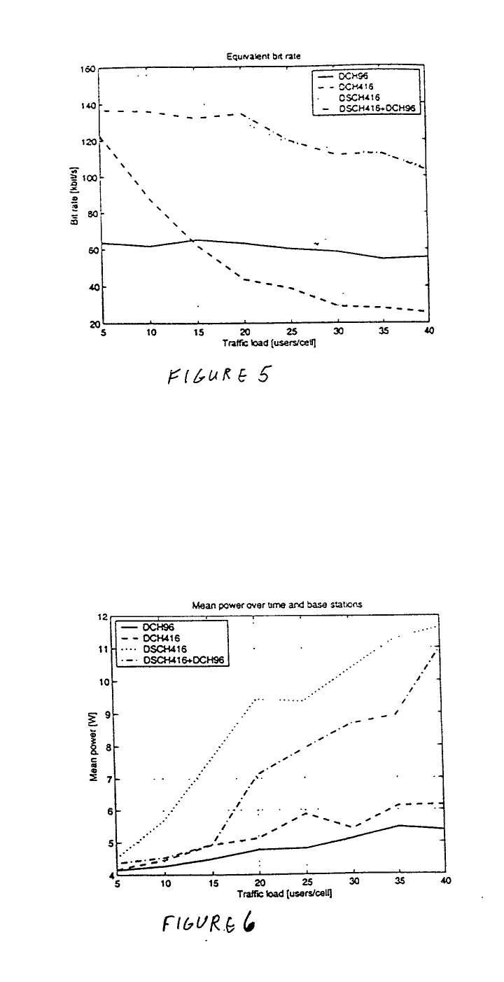

FIG. 6 illustrates the mean downlink transmission power as a function of the average number of web browsing users per cell for each of the four simulated schemes. In FIG. 6, the base station transmission power, averaged over the simulation time and over all base stations, is plotted against the average number of web browsing users per cell for each of the four simulated schemes. As expected, soft handover gain results in lower power for the DCH schemes. However, the DSCH 416+DCH 96 scheme utilizes considerably less base station transmission power than the pure DSCH 416 scheme.

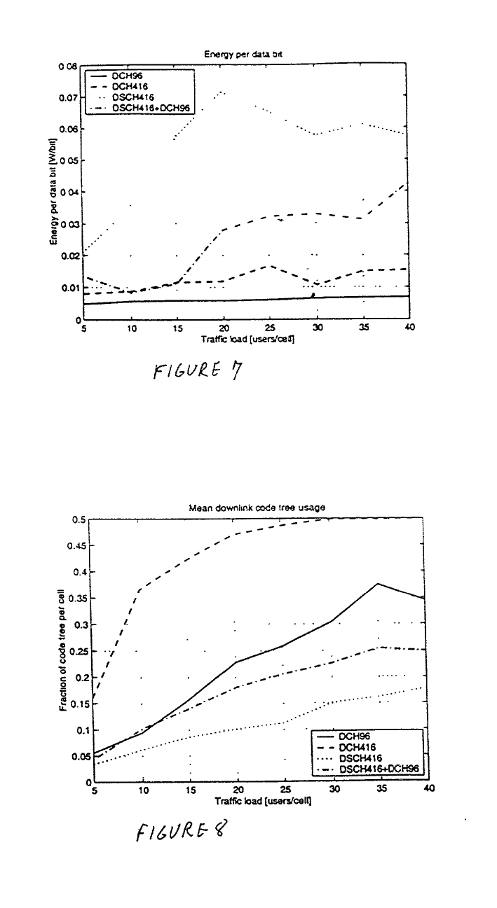

FIG. 7 illustrates the transmitted energy per correctly received data bit as a function of the average number of web browsing users per cell for each of the four simulated schemes. FIG. 7 once again illustrates that the DSCH 416+DCH 96 scheme utilizes considerably less base station transmission power than the pure DSCH 416 scheme.

FIG. 8 illustrates the mean code tree usage as a function of the average number of web browsing users per cell for each of four simulated schemes. From FIG. 8, the high channelization code occupation of the DCH schemes can be observed. However, the DSCH 416+DCH 96 scheme according to the present invention utilizes only 5-10 percentage units more code resources than the DSCH 416 scheme.

The simulations results presented in FIGS. 5-8 illustrate the performance that may be gained in a WCDMA system as a result of the application of the present invention.

The present invention provides for a simple and robust method to combine the advantages of downlink shared channels (DSCH) which provide code saving advantages, and dedicated channels (DCH) which provide downlink power savings, by switching users between the two channel schemes according to measured conditions. An additional advantage of the method of the present invention is that it does not require changes to be made to the existing 3GPP specification.

Although the exemplary method of the present invention was illustrated as being used in a WCDMA communication system, the present invention may be used in any communication system which uses dedicated and shared channels for communication, such as a CDMA system.

Although various embodiments of the method, system, and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the scope of the invention as set forth and defined by the following claims.

What is claimed is:

1. A system for allocating radio resources in a communication system, said system comprising:
a base station providing a downlink shared channel and a downlink dedicated channel;
a user terminal in communication with said base station, said user terminal being allocated one of said downlink shared channel and said downlink dedicated channel; and
a switching means for switching said user terminal between said downlink shared channel and said downlink dedicated channel based upon a signal threshold.

2. The system of claim 1, wherein said signal threshold is a distance measurement.

3. The system of claim 2, wherein said distance measurement is selected from the group consisting of a link quality to a serving cell, a link quality to a second best cell, a downlink shared channel power associated with said user terminal, and an expected downlink shared channel power associated with said user terminal.

4. The system of claim 1, wherein said signal threshold is a downlink path loss measurement from said user terminal.

5. The system of claim 1, wherein said system is a wideband code division multiple access (WCDMA) system.

6. The system of claim 1, wherein said base station comprises a Node B component.

7. The system of claim 1, said system further comprising:
a base station controller in communication with said base station; and
a core network in communication with said base station controller.

8. The system of claim 7, wherein said core network is selected from the group consisting of a public switched telephone network (PSTN) and a wireless communication network.

9. The system of claim 7, wherein said base station controller is a radio network controller (RNC).

10. A method for switching a user from a downlink shared channel to a downlink dedicated channel in a communication system, said method comprising the steps of:
(a) determining the availability of dedicated channel codes within said communication system;
(b) determining a link quality within said communication system;
(c) determining a downlink shared channel power associated with said user;
(d) switching said user from said downlink shared channel to said downlink dedicated channel if said dedicated channel codes in step (a) are available and said link quality within said communication system in step (b) is less than a first threshold; and
(e) switching said user from said downlink shared channel to said downlink dedicated channel if said dedicated channel codes in step (a) are available and said downlink shared channel power associated with said user in step (c) is greater than a second threshold.

11. The method of claim 10, said step of determining a link quality within said communication system further comprising the step of:
determining a differential between a link quality to a serving cell and a link quality to a second best cell.

12. The method of claim 10, wherein said link quality is a power-to-interference ratio.

13. The method of claim 10, said step of determining a downlink shared channel power associated with said user further comprising the steps of:
estimating the power of an associated downlink dedicated physical control channel (DPCCH); and
adding an offset value associated with a difference in transmitted power between said associated downlink dedicated physical control channel (DPCCH) at a desired quality and said downlink shared channel at a desired quality.

14. The method of claim 13, wherein said step of estimating the power of said associated downlink dedicated physical control channel (DPCCH) is performed in a base station.

15. The method of claim 14, wherein said base station comprises a Node B component.

16. The method of claim 10, wherein said first threshold is a desired cell differential switching level.

17. The method of claim 10, wherein said second threshold is a desired dedicated shared channel power switching level.

18. A method for switching a user from a downlink dedicated channel to a downlink shared channel in a communication system, said method comprising the steps of:
(a) determining a potential of a channel code shortage within said communication system;
(b) determining a link quality within said communication system;
(c) determining an expected downlink shared channel power associated with said user;
(d) switching said user from said downlink dedicated channel to said downlink shared channel if said potential of a channel code shortage within said system in step (a) is present; and
(e) switching said user from said downlink dedicated channel to said downlink shared channel if said link quality within said communication system in step (b) is greater than a first threshold, and said expected downlink shared channel power associated with said user in step (c) is less than a second threshold.

19. The method of claim 18, said step of determining a link quality within said communication system further comprising the step of:
determining a differential between a link quality to a serving cell and a link quality to a second best cell.

20. The method of claim 18, wherein said link quality is a power-to-interference ratio.

21. The method of claim 18, said step of determining an expected downlink shared channel power associated with said user further comprising the steps of:
estimating a current value of a downlink dedicated channel power; and
adding an offset value associated with a difference in transmitted power between an associated downlink dedicated physical control channel (DPCCH) at a desired quality and said downlink shared channel at a desired quality.

22. The method of claim 21, wherein said step of estimating a current value of a downlink dedicated channel power is performed in a base station.

23. The method of claim 22, wherein said base station comprises a Node B component.

24. The method of claim 18, wherein said first threshold is a desired cell differential switching level.

25. The method of claim 18, wherein said second threshold is a desired dedicated shared channel power switching level.

26. A method for switching a user from a first channel to a second channel in a communication system, said method comprising the steps of:
(a) determining a channel code availability criteria within said communication system;
(b) determining a link quality criteria within said communication system;
(c) determining a channel power criteria associated with said user; and
(d) switching said user from said first channel to said second channel based upon said channel code availability criteria, said link quality criteria, and said channel power criteria.

27. The method of claim 26, wherein said first channel is a downlink dedicated channel and said second channel is a downlink shared channel.

28. The method of claim 26, wherein said first channel is a downlink shared channel and said second channel is a downlink dedicated channel.

29. The method of claim 26,wherein said communication system is a wideband code division multiple access (WCDMA) system.

30. A base transceiver apparatus for allocating downlink channels to a user terminal, said base transceiver apparatus comprising:
a base station for providing a downlink shared channel and a downlink dedicated channel;
an allocation means for allocating one of said downlink shared channel and said downlink dedicated channel to said user terminal; and
a switching means for switching said user terminal between said downlink shared channel and said downlink dedicated channel based upon a signal threshold.

31. The base transceiver apparatus of claim 30, wherein said signal threshold is a distance measurement.

32. The base transceiver apparatus of claim 31, wherein said distance measurement is selected from the group consisting of a link quality to a serving cell, a link quality to a second best cell, a downlink shared channel power associated with said user terminal, and an expected downlink shared channel power associated with said user terminal.

33. The system of claim 30, wherein said signal threshold is a downlink path loss measurement from said user terminal.

34. The system of claim 30, wherein said base transceiver apparatus is a wideband code division multiple access (WCDMA) Node B component.
